(19) United States
(12) Patent Application Publication
(10) Pub. No.: US 2005/0058854 A1
(43) Pub. Date: Mar. 17, 2005

(54) Perpendicular magnetic recording medium and manufacturing of the same

(75) Inventors: Ikuko Takekuma, Yokohama (JP); Hiroyuki Nakagawa, Yokohama (JP); Ichiro Tamai, Odawara (JP); Yoshiyuki Hirayama, Kokubunji (JP); Yuzuru Hosoe, Hino (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/875,601

(22) Filed: Jun. 25, 2004

(30) Foreign Application Priority Data
Sep. 12, 2003 (JP) 2003-320605
Sep. 16, 2003 (JP) 2003-322433

(51) Int. Cl. G11B 5/84; G11B 5/667; G11B 7/26

(52) U.S. Cl. 428/694 TM; 369/13.42; 369/288; 428/694 TS

(57) ABSTRACT

Disclosed here is a perpendicular magnetic recording medium for realizing a high media S/N value without degrading the magnetic isolation of crystal grains from each another. The perpendicular magnetic recording medium comprises a substrate, a soft magnetic underlayer formed on the substrate, an intermediate layer formed on the soft magnetic underlayer, and a magnetic recording layer formed on the intermediate layer. The intermediate layer consists of at least two or more layers and contains Ru or an Ru alloy and the magnetic recording layer is made of a material containing a CoCrPt alloy and oxygen. The crystallo graphic orientation of the recording layer can be improved enough without increasing the crystal grain size if a full width at half-maximum Δθ₅₀ of the Rocking curves of the Ru (0002) diffraction peak measured by an X-ray diffraction method is 5° and under.

### CLAIM OF PRIORITY

The present application claims priority from Japanese application JP 2003-320605 filed on Sep. 12, 2003, and Japanese application JP 2003-322433 filed on Sep. 16, 2003, the contents of which are hereby incorporated by reference into this application.

### FIELD OF THE INVENTION

The present invention relates to a perpendicular magnetic recording medium and a method for manufacturing the same.

### BACKGROUND OF THE INVENTION

The areal density of magnetic disk drives has increased by 100% every year since 1998. As the areal density increases, however, a so-called thermal decay problem has begun to arise remarkably. Consequently, it has been considered to be very difficult to go over an areal density of 15.5 gigabits per square centimeter.

On the other hand, unlike the longitudinal recording method, the perpendicular recording method causes the demagnetizing field that works between adjacent bits to be reduced in proportion to an increase of the linear recording density, thereby the recording magnetization is kept stably. This is why the method is effective to realize such high density recording.

Recent years, it has been proposed to use a so-called oxide granular medium as a perpendicular magnetic recording medium having excellent thermal stability and high media S/N. The oxide granular medium uses a material in which an oxide is added to a CoCrPt alloy to form the magnetic recording layer. For example, the non-patent document 1 discloses a CoCrPt—SiO₂ granular medium.

To realize such high density recording as described above, it is required to improve the media S/N value more and it is considered to be effective to promote reducing of the crystal grain size and magnetic isolation of the crystal grains in the magnetic recording layer to obtain such a high media S/N value. And, in order to control both size and structure of the crystal grains in the magnetic recording layer, the intermediate layer formed between the magnetic recording layer and the soft magnetic underlayer is required to be improved more.

The patent document 1 proposes a method for adding a second element to an Ru intermediate layer. This method is effective for reducing of the crystal grain size and magnetic isolation of crystal grains from each another in the magnetic recording layer. However, the method cannot obtain sufficient crystallo graphic orientation, so that the method might not be so effective to achieve a high S/N value.

And, the patent document 2 proposes a method for changing the Ar gas pressure for depositing the Ru intermediate layer. According to the method, it is possible to promote magnetic isolation of crystal grains from each another. However, at that time, the crystallo graphic orientation is degraded due to the promotion of the magnetic isolation of the crystal grains, so that the method might also not be so effective to achieve a high S/N value. The crystal orientation is often sacrificed, since priority is usually given to the reducing of crystal grain size and magnetic isolation of crystal grains such way.

On the other hand, as disclosed in the patent documents 3 and 4, there is another method proposed to use a seed layer and an orientation control layer effective to improve the crystallo graphic orientation, and still another method, as disclosed in the patent documents 5 and 6, proposed to improve the crystallo graphic orientation by reducing the lattice constant mismatch between the intermediate layer and the magnetic recording layer.
[Patent document 1] Official gazette of JP-A No.334424/2002
[Patent document 2] Official gazette of JP-A No.197630/2002
[Patent document 3] Official gazette of JP-A No.178412/2003
[Patent document 4] Official gazette of JP-A No.123239/2003
[Patent document 5] Official gazette of JP-A No.178413/2003
[Patent document 6] Official gazette of JP-A No.203330/2003
[Non-patent document 1] IEEE Trans. Magn., vol.38, p.1976 (2002)

Using those methods will make it possible for crystal grains to grow from the intermediate layer up to the magnetic recording layer continuously, thereby the crystal grain size increases easily. In addition, generation of defects and strains at each boundary between crystal grains are suppressed and non-magnetic grain boundaries are not formed so easily. Consequently, the magnetic isolation of crystal grains from each another is suppressed. The media S/N value thus becomes not high enough.

### SUMMARY OF THE INVENTION

Under such circumstances, it is an object of the present invention to realize a high media S/N value without degrading the magnetic isolation of crystal grains from each another. Such a high media S/N value is realized by promoting the magnetic isolation of crystal grains and reducing of crystal grain size.

In order to achieve the above object, according to one aspect, the perpendicular recording medium of the present invention comprises a substrate, a soft magnetic underlayer formed on the substrate, an intermediate layer formed on the soft magnetic underlayer, and a magnetic recording layer formed on the intermediate layer. The intermediate layer consists of at least two or more layers and contains Ru or an Ru alloy. The magnetic recording layer is made of a material containing a CoCrPt alloy and oxygen. The full width at half-maximum Δθ₅₀ of the Rocking curves of the Ru (0002) diffraction peak measured by an X-ray diffraction (XRD) method is 5° and under.

Actually, the intermediate layer consists of a lower intermediate layer and an upper intermediate layer. The upper intermediate layer is made of Ru or an alloy in which at least one of a Si oxide, an Al oxide, Ag, and Cu is added to Ru. The lower intermediate layer is made of Ru or an Ru-based alloy in which at least one of Co and Cr is added to the Ru.

The perpendicular magnetic recording medium formed as described above has crystallo graphic orientation improved enough without increasing the crystal grain size in the magnetic recording layer, so that the medium comes to be provided with a high S/N value.

And, according to one aspect of the present invention, the method for manufacturing the perpendicular magnetic recording medium forms the medium as follows. At first, a soft magnetic underlayer is formed on a substrate, then a lower intermediate layer is formed on the soft magnetic underlayer. The lower intermediate layer contains Ru or an Ru-based alloy in which at least one of Co or Cr is added to the Ru. After that, an upper intermediate layer is formed on the lower intermediate layer at a deposition rate lower than that of the lower intermediate layer. The upper intermediate layer contains Ru or an alloy in which at least one of an Si oxide, an Al oxide, Ag, and Cu is added to the Ru. And, a magnetic recording layer is formed on the upper intermediate layer.

According to another aspect of the present invention, the method for manufacturing the perpendicular magnetic recording medium forms the medium as follows. At first, a soft magnetic underlayer is formed on a substrate. Then, a lower intermediate layer is formed on the soft magnetic underlayer in an Ar gas atmosphere. The lower intermediate layer contains Ru or an Ru alloy in which at least one of Co and Cr is added to the Ru. After that, an upper intermediate layer is formed on the lower intermediate layer in an Ar gas atmosphere having a gas pressure higher than that of the lower intermediate layer. The upper intermediate layer contains Ru or an alloy in which at least one of an Si oxide, an Al oxide, Ag, and Cu is added to the Ru. Finally, a magnetic recording layer is formed on the upper intermediate layer.

According to the method for manufacturing the perpendicular magnetic recording medium configured as described above, the crystallo graphic orientation is improved enough while suppressing the crystal grain size in the magnetic recording layer, thereby enabling high S/N perpendicular magnetic recording media to be manufactured.

According to the present invention, therefore, a high medium S/N value is realized by improving the crystallo graphic orientation while suppressing the crystal grain size without degrading the magnetic isolation of crystal grains from each another. Furthermore, the crystal grain isolation is promoted and the crystal grains are miniaturized more while the crystallo graphic orientation is improved, thereby realizing a high medium S/N value.

### BRIEF DESCRIPTION OF THE DRAWINGS

FIG. 1 illustrates a structure of a perpendicular magnetic recording medium in each of examples 1 to 6 of the present invention;

FIG. 2 illustrates a relationship between the full width at half-maximum Δθ₅₀ of the Rocking curves of the Ru (0002) diffraction peak measured by an X-ray diffraction method employed in the example 1 of the present invention and in the comparative example 1 and a media S/N value;

FIG. 3 illustrates a relationship between the Ru content in the upper-intermediate layer of the perpendicular magnetic recording medium in the example 2 of the present invention and a media S/N value;

FIG. 4 illustrates a relationship between the Ru content of the upper-intermediate layer of the perpendicular magnetic recording medium in the example 2 of the present invention and the mean crystal grain size in the magnetic recording layer, which is obtained by calculation from observation of crystal grain images by a TEM (Transmission Electron Microscope) and the mean crystal grain size obtained by calculation in analysis of the images;

FIG. 5 illustrates a relationship between a media S/N value and the mean crystal grain boundary width obtained through observation of the crystal grain images in the perpendicular magnetic recording medium in examples 1 and 2 of the present invention, as well as the comparative example 1 and through analysis of the images;

FIG. 6 illustrates a result of composition analysis of the perpendicular magnetic recording medium in the example 3 of the present invention by X-ray photoelectron spectroscopy (XPS);

FIG. 7 illustrates a relationship between a coercivity Hc and the mean crystal grain size in the magnetic recording layer, obtained by calculation through observation of crystal grain images of the perpendicular magnetic recording medium in the example 3 of the present invention and comparative example 3 by a TEM (Transmission Electron Microscope) and through analysis of those images;

FIG. 8 illustrates a relationship between a mean crystal grain boundary width and a mean crystal grain size in the magnetic recording layer, obtained by calculation through observation of crystal grain images of the perpendicular magnetic recording medium in the example 3 of the present invention and comparative example 3 by a TEM (Transmission Electron Microscope) and through analysis of those images;

FIG. 9 illustrates a relationship between the film thickness of the lower-intermediate layer of the perpendicular magnetic recording medium in the example 4 of the present invention and the coercivity Hc normalized by the coercivity value of the lower-intermediate layer thickness 20 nm;

FIG. 10 illustrates a relationship between the film thickness of the lower-intermediate layer of the perpendicular magnetic recording medium in the example 4 of the present invention and the value of the full width at half-maximum Δθ₅₀ of the Rocking curves of the Ru (0002) diffraction peak measured by an X-ray diffraction method;

FIG. 11 illustrates a relationship between a media S/N value and a content of an Si oxide added to the upper-intermediate layer of the perpendicular magnetic recording medium in the example 5 of the present invention and comparative example 5; and

FIG. 12 illustrates a relationship between a coercivity Hc and the film thickness of the upper-intermediate layer of the perpendicular magnetic recording medium in the example 6.

### DETAILED DESCRIPTION OF THE PREFERRED EMBODIMENTS

Hereunder, the perpendicular magnetic recording medium of the present invention will be described in detail with reference to the accompanying drawings.

The perpendicular magnetic recording medium of the present invention includes at least a soft magnetic underlayer, an intermediate layer, a magnetic recording layer, and an overcoat layer laminated sequentially on a substrate. The intermediate layer is made of Ru or an Ru alloy and the magnetic recording layer is made of an CoCrPt alloy and another alloy containing oxygen. And, a full width at half-maximum Δθ₅₀ of the Rocking curves of the Ru (0002) diffraction peak is 5° and under. More preferably, the Ru alloy should contain Ru by 50 at. % and over.

If the intermediate layer is made of Ru or an Ru-based alloy containing Ru by 50 at. % and over such way, the lattice constant mismatch between the intermediate layer and the magnetic recording layer becomes significant, and an action works in the magnetic recording layer so as to ease the lattice distortion caused by such lattice constant mismatch. As a result, even if the crystallo graphic orientation of the intermediate layer is improved, crystal grain boundaries in the magnetic recording layer come to be generated easily.

This is why the present invention can obtain a magnetic recording layer in which the crystallo graphic orientation is good, the grain size is small, and grains are well-isolated magnetically from each another. And, the recording medium can have a high S/N value. However, if the crystallo graphic orientation of the intermediate layer made of Ru or an Ru-based alloy is not good enough, concretely if the a full width at half-maximum Δθ₅₀ of the Rocking curves of the Ru (0002) diffraction peak is over 5°, the lattice constant mismatch between the intermediate layer and the magnetic recording layer increases, thereby the crystallo graphic orientation of the magnetic recording layer is degraded significantly and the medium S/N value goes low.

In the present invention, it is found that one of the effective methods for improving the medium S/N value is to make good use of the lattice constant mismatch between the intermediate layer and the magnetic recording layer after improving the crystallo graphic orientation of the Ru or the Ru alloy enough.

In order to realize the medium configuration as described above, according to one aspect of the present invention, in the perpendicular magnetic recording medium, the lower-intermediate layer is made of Ru or an Ru-based alloy, the upper-intermediate layer is made of Ru or an alloy in which at least one of an Si oxide, an Al oxide, Ag, and Cu is added to the Ru, and the magnetic recording layer is made of a CoCrPt alloy and another alloy containing oxygen. And, the a full width at half-maximum Δθ₅₀ of the Rocking curves of the Ru (0002) diffraction peak measured by an X-ray diffraction method is 5° and under.

Because the intermediate layer of this medium has such good crystallo graphic orientation (a full width at half-maximum Δθ₅₀ of the Rocking curves of the Ru (0002) diffraction peak is 5° and under) and the upper-intermediate layer located just under the magnetic recording layer is made of an alloy in which an oxide is added to Ru, the magnetic recording layer can have good crystallo graphic orientation and well-isolated crystal grains which are as small as 7 nm and under in size. As a result, the medium S/N value is improved more.

In order to manufacture such a perpendicular magnetic recording medium, it is required to form a soft magnetic underlayer on a substrate first, then form a lower-intermediate layer containing Ru or an Ru-based alloy in which at least one of Co and Cr is added to the Ru, on the soft magnetic underlayer, then form an upper-intermediate layer containing Ru or an alloy in which at least one of an Si oxide, Al oxide, Ag, and Cu is added to the Ru, on the lower-intermediate layer at a deposition rate lower than that of the lower-intermediate layer, and finally form a magnetic recording layer on the upper-intermediate layer.

According to another aspect of the present invention, the perpendicular magnetic recording medium is formed as follows. At first a soft magnetic underlayer is formed on a substrate, then a lower-intermediate layer containing Ru or an Ru-based alloy in which at least one of Co and Cr is added to the Ru is formed on the soft magnetic underlayer in an Ar gas atmosphere, then an upper-intermediate layer containing Ru or an alloy in which at least one of an Si oxide, Al oxide, Ag, and Cu is added to the Ru is formed on the lower-intermediate layer at a higher gas pressure than that of the lower-intermediate layer, and finally a magnetic recording layer is formed on the upper-intermediate layer.

More concretely, the intermediate layer should preferably be formed by laminating a lower-intermediate layer and an upper-intermediate layer sequentially in different deposition processes so that the lower-intermediate layer is formed by either of a spattering method in an Ar gas atmosphere between 0.5 Pa and 1 Pa or spattering method at a deposition rate of 2 nm/s and over. And, the upper-intermediate layer is formed by either of a spattering method in an Ar gas atmosphere between 2 Pa and 6 Pa or spattering method at a deposition rate of 1 nm/s and under.

Otherwise, the lower-intermediate layer is formed by either of a spattering method in an Ar gas atmosphere between 0.5 Pa and 1 Pa or spattering method at a deposition rate of 2 nm/s and over. And, the upper-intermediate layer is made of Ru or an alloy in which at least one of an Si oxide, an Al oxide, Ag, and Cu is added to the Ru.

The perpendicular magnetic recording medium in this embodiment of the present invention is manufactured using an ANELVA spattering apparatus (C3010). The apparatus (C3010) comprises 10 process chambers and one substrate loading/unloading chamber and each chamber is evacuated independently. The evacuation performance of every chamber is 6×10⁻⁶ Pa and under.

In each spattering process chamber is provided a rotary magnetron spattering cathode and in one of the spattering process chambers is provided a special cathode referred to as a rotating cathode. The rotating cathode is a assembly of three cathodes, each of which can control a supply power independently. The rotating speed is 100 rpm in maximum. The magnetic recording layer and the intermediate layer are formed in the process chamber provided with the rotating cathode. The heating process chamber is provided with an infrared lamp heater. The heating temperature is controlled according to both supply power and supply time.

The crystal grain size is evaluated as follows. A TEM (Transmission Electron Microscope) is used to observe the crystal grain images and analyze the images to measure the crystal grain size and the grain boundary width. At first, a magnetic recording medium sample (disk) is cut into about 2 mm square pieces. This sample piece is then polished so that only the magnetic recording layer and the overcoat layer are left over partially as a very thin film. This thin film sample is observed from the direction vertical to the substrate using the TEM (Transmission Electron Microscope) and the bright field image is obtained.

In a bright field image of a granular medium, the crystal grain portion and the grain boundary portion are distinguished clearly, since the crystal grain portion is strong in diffraction intensity and the grain boundary portion is weak in diffraction intensity. And, a line is drawn at each boundary between dark visual portions of crystal grains and bright visual portions of grain boundaries to obtain a crystal grain image. After that, the obtained image is fetched into a personal computer with use of a scanner as digital data.

The digital image data in the personal computer is then analyzed to obtain the number of pixels in each grain, then obtain the area of each grain by converting the number of pixels to a real scale value. The grain size is defined as a diameter of a circle having an area equal to the grain area obtained above. This measurement is made for each of more than 300 grains to define the obtained grain size as an arithmetical mean grain size.

Next, a description will be made for how to measure a grain boundary width in the magnetic recording layer. At first, the center of the gravity of each grain is obtained, then a line is drawn between the centers of the gravity of adjacent grains to obtain the length of the grain boundary represented by the number of pixels. The obtained grain boundary length is converted to a real scale value to obtain the length of the grain boundary. This measurement is repeated for each of more than 300 grain boundaries and averaged arithmetically to define the result as a mean grain boundary width.

The crystallo graphic orientation of the intermediate layer made of Ru or an Ru-based alloy is measured as follows; an X-ray diffraction (XRD) method is used to measure the Rocking curves of the Ru(0002) diffraction peak and evaluate it by the full width at half-maximum Δθ₅₀.

The coercivity Hc of the magnetic recording layer is evaluated as follows. A Kerr effect magnetometer is used to measure the coercivity Hc. A Kerr rotation angle is detected while applying a magnetic field in an direction vertical to the film surface to measure the Kerr loop. At that time, the magnetic field is swept at a fixed speed between +22 kOe and −22 kOe for 64 seconds. If the recording layers are the same in composition, the Hc is usable as a standard of exchange interaction levels between crystal grains. If the exchange interaction is strong between crystal grains, the Kerr loop is inclined more and the Hc value decreases. On the other hand, if the exchange interaction between crystal grains is weak, the Kerr loop is inclined less and the Hc value increases.

The recording/reproducing characteristics are evaluated using a spin stand and a head with a single-pole type (SPT) writer and a GMR reader. The shield-gap length is 62 nm, and the read width is 120 nm, and the write width is 150 nm. The media S/N value is evaluated by a ratio between the output amplitude at 50 kFCI and the media noise at 600 kFCI.

Hereunder, a description will be made for the preferred embodiments of the present invention with reference to the accompanying drawings.

### EXAMPLES

### Example 1

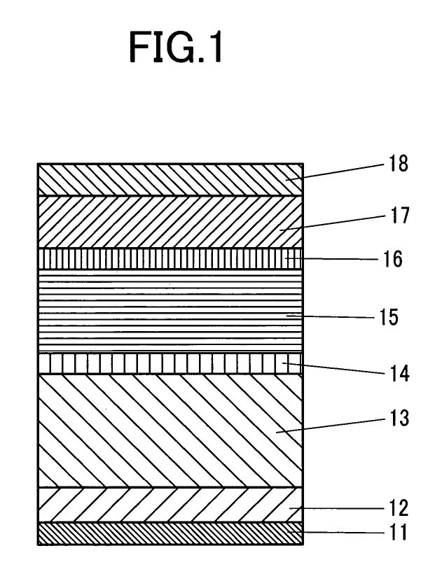

FIG. 1 describes a block diagram of a perpendicular magnetic recording medium in the example 1. On a substrate 11 are formed a pre-coat layer 12, a soft magnetic underlayer 13, a seed layer 14, a lower-intermediate layer 15, an upper-intermediate layer 16, a magnetic recording layer 17, and an overcoat layer 18 that are laminated sequentially on the substrate 11.

The substrate 11 is a crystallized glass substrate having a thickness of 0.635 mm and a diameter of 65 mm. At first, an Ni-37.5 at. % Ta-10 at. % Zr pre-coat layer 12 (NiTa_{37.5}Zr₁₀, hereinafter) is formed on the substrate to suppress the influence of chemical heterogeneity of the substrate surface and ununiformity of the temperature in the thermal treatment process on the soft magnetic underlayer. Then, a soft magnetic underlayer 13 is formed on the pre-coat layer 12. The soft magnetic underlayer 13 is made of FeTa₈C₁₂ having a total thickness of 200 nm.

The soft magnetic underlayer 13 is structured as a multilayer provided with a 0.3 nm Ta layer as a intermediate layer so as to obtain a spike noise reduction effect. The thermal treatment is applied to the layer 13 at an ultimate temperature of about 400° C., a supply power of 1920 W, and a heating time of 12 seconds.

After that, the substrate is cooled down to 80° C. and under, then a seed layer 14, a lower-intermediate layer 15, and an upper-intermediate layer 16 are formed, then a magnetic recording layer 17 having a thickness of 14 nm and a CN overcoat layer 18 having a thickness of 4 nm are formed thereon. In the magnetic recording layer 17, an Si oxide is added to a CoCr₁₇Pt₁₄ alloy by 17.5 vol.

An Ar gas is used as a spattering gas. The total gas pressure is set at 1.0 Pa to form the pre-coat layer 12, soft magnetic underlayer 13, and the seed layer 14 and at 4 Pa to form the magnetic recording layer 17, and at 0.6 Pa to form the overcoat layer 18.

Oxygen is added to the Ar gas with a partial pressure of 15 mPa to form the magnetic recording layer 17, and nitrogen is added to the Ar gas with a partial pressure of 15 mPa to form the overcoat layer 18.

In order to make a comparison with the sample in the example 1, the upper-intermediate layer 16 is deposited under the same condition as that of the lower-intermediate layer 15 to obtain the sample in the comparative example 1.

Table 1 shows the deposition condition, material, and thickness of each of the seed layer 14, the lower-intermediate layer 15, and the upper-intermediate layer 16 in the example 1. In each sample shown in the example 1 and the comparative example 1, Ru is used for both of the lower-intermediate layer 15 and the upper-intermediate layer 16. The mean crystal grain size and the mean grain boundary width of the magnetic recording layer are almost the same (mean grain size: about 7.5 nm, mean grain boundary width: 1.1 nm) between the samples in the example 1 and the comparative example 1. Both of the mean grain size and the mean grain boundary width are obtained by calculation through the observation of the grain images by a TEM (Transmission Electron Microscope) and through the analysis of those images.

TABLE 1

| | | Lower-intermediate | | Upper-intermediate | | | | |
|---|---|---|---|---|---|---|---|---|
| | | layer (15 nm) | | layer (5 nm) | | | Grain- | |
| | Seed layer | Deposition | Ar | Deposition | Ar | | boundary | |
| Sample | (1 nm) | rate | pressure | rate | pressure | Δθ₅₀ | width | S/Nm |
| name | Material | (nm/s) | (Pa) | (nm/s) | (Pa) | (degree) | (nm) | (dB) |
| 1-1 | Ta | 0.5 | 2.2 | 0.5 | 2.2 | 5.3 | 1.10 | 18.2 |
| 1-2 | Ta | 0.5 | 5.5 | 0.5 | 5.5 | 5.8 | 1.15 | 18.4 |
| 1-3 | Ni-37.5at. % Ta | 0.5 | 2.2 | 0.5 | 2.2 | 7.0 | 1.20 | 17.7 |
| 1-4 | Ni-37.5at. % Ta | 0.5 | 5.5 | 0.5 | 5.5 | 7.6 | 1.22 | 17.2 |
| 1-5 | Ta | 1.0 | 0.9 | 1.2 | 2.2 | 4.9 | 1.12 | 21.0 |
| 1-6 | Ta | 1.0 | 0.9 | 0.5 | 2.2 | 5.0 | 1.12 | 21.2 |
| 1-7 | Ta | 6.5 | 0.9 | 0.5 | 2.2 | 4.8 | 1.08 | 21.5 |
| 1-8 | Ta | 1.0 | 0.6 | 0.5 | 2.2 | 4.7 | 1.20 | 21.6 |
| 1-9 | Ta | 6.5 | 0.6 | 0.5 | 2.2 | 4.5 | 1.08 | 21.9 |
| 1-10 | Ta | 6.5 | 0.6 | 0.5 | 5.5 | 4.6 | 1.05 | 22.1 |

Samples 1-1 to 1-4: Comparative example 1
Samples 1-5 to 1-10: Example 1

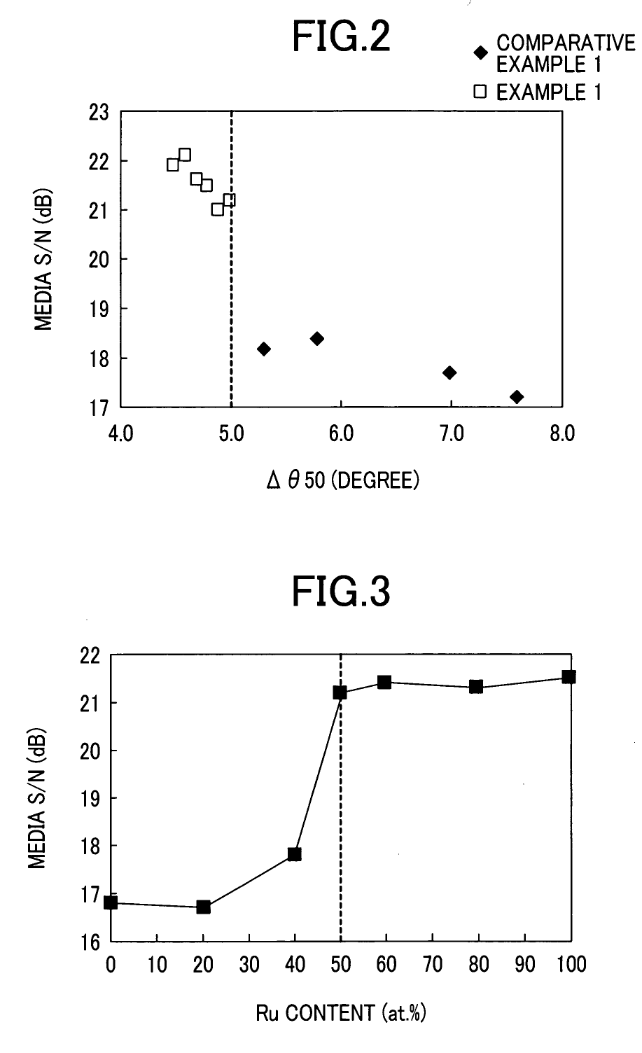

FIG. 2 illustrates a relationship between a media S/N value and a full width at half-maximum Δθ₅₀ of the Rocking curves of the Ru (0002) diffraction peak measured by an X-ray diffraction method. As shown clearly in FIG. 2, in the comparative example 1 in which both of the lower-intermediate layer 15 and the upper-intermediate layer 16 are formed under the same deposition condition, the Δθ₅₀ value is over 5° and the media S/N value is far lower than that of the sample in the example 1.

On the other hand, in the sample in the example 1, the a full width at half-maximum Δθ₅₀ of the Rocking curves of the Ru (0002) diffraction peak measured by an X-ray diffraction method is 5° and under, resulting in good crystallo graphic orientation. As described above, the sample in the example 1 uses a lower-intermediate layer 15 formed by either of the spattering in an Ar gas atmosphere between 0.5 Pa and 1 Pa or the spattering performed at a deposition rate of 2 nm/s or more and an upper-intermediate layer 16 formed by either of the spattering in an Ar gas atmosphere between 2 Pa and 6 Pa or the spattering performed at a deposition rate of 1 nm/s or less. This means that the media S/N in the example 1 is far higher than that of the sample in the comparative example 1.

In other words, the medium having good crystallo graphic orientation (a full width at half-maximum Δθ₅₀ of the Rocking curves of the Ru (0002) diffraction peak measured by an X-ray diffraction method is 5° and under) can obtain a high media S/N value that cannot be obtained from any medium having crystallo graphic orientation having a full width at half-maximum Δθ₅₀ that is over 5°.

### Example 2

The perpendicular magnetic recording medium in this example 2 is manufactured in the same film structure and under the same deposition condition as those of the sample 1-7 in the example 1 except for the material of the upper-intermediate layer 16. In this example 2, the upper-intermediate layer 16 is made of a RuCo alloy in which the Ru content is changed from that in the example 1.

FIG. 3 illustrates a relationship between the Ru content and the media S/N value. As shown in FIG. 3, the media S/N value is lowered significantly when the Ru content is under 50 at. %. This admits that the more the Co content increases and the more the Ru content decreases, the less the lattice constant mismatch between the magnetic recording layer and the intermediate layer is reduced, thereby adjacent crystal grains come to be united more easily.

In other words, it is required to set the Ru content in the Ru-based alloy intermediate layer at 50 at. % and over and increase the lattice constant mismatch between the magnetic recording layer and the intermediate layer to obtain a high media S/N value. The same result is also obtained when RuCr and RuCrCo alloy are used for forming the upper-intermediate layer.

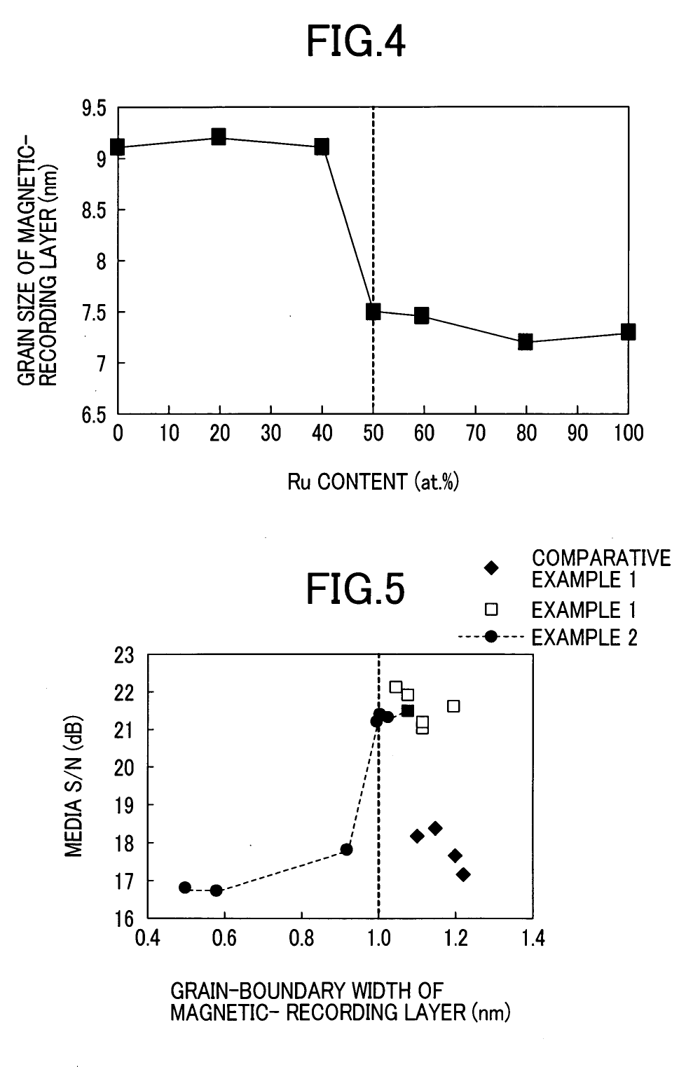

FIG. 4 shows a check result of the dependency of the crystal grain size of the magnetic recording layer on the Ru content. The result is obtained by measuring the mean crystal grain size of the magnetic recording layer, obtained by calculation through the observation of crystal grain images of the medium in the example 2 by a TEM (Transmission Electron Microscope) and through the analysis of the those grain images. It has found that the grain size of the magnetic recording layer increases suddenly at the Ru content less than 50 at. %.

Therefore, as shown in FIGS. 3 and 4, in order to obtain a high media S/N value, it is required to increase the Ru content in the Ru alloy intermediate layer to 50 at. % and over and suppress the crystal grain size in the magnetic recording layer to 7.5 nm and under. The same effect is also obtained when RuCr and RuCrCo alloy are used for forming the upper-intermediate layer.

FIG. 5 shows a check result of a relationship between the media S/N value and the mean crystal grain boundary width in the magnetic recording layer, obtained by calculation through the observation of crystal grain images of each medium manufactured in the examples 1 and 2 by a TEM (Transmission Electron Microscope) and through the analysis of those grain images.

It is understood that the media S/N value decreases significantly in each sample when the crystal grain boundary width is under 1 nm. When the mean crystal grain boundary width is 1 nm and over, it is found that the smaller the Δθ₅₀ of the Ru(0002) diffraction peak of the intermediate layer is, the higher the media S/N value is apt to become.

If crystal grain boundary isolation in the magnetic recording layer is insufficient when the crystal grain boundary width in the magnetic recording layer is under 1 nm as described above, it is impossible to obtain a high media S/N value even if the crystallo graphic orientation is improved. Consequently, the crystal grain boundary width in the magnetic recording layer must be 1 nm and over.

### Example 3

The perpendicular magnetic recording medium in this example 3 is manufactured in the same film structure and under the same deposition condition as those of the sample 1-7 in the example 1 except for the upper-intermediate layer. In the sample in this example 3, a Ru alloy having a thickness of 5 nm is used to form the upper-intermediate layer. In the Ru alloy, a Si oxide is added to the upper-intermediate layer. The content of the Si oxide to be added in the upper-intermediate layer is changed to create a sample having a different mean crystal grain size in the magnetic recording layer.

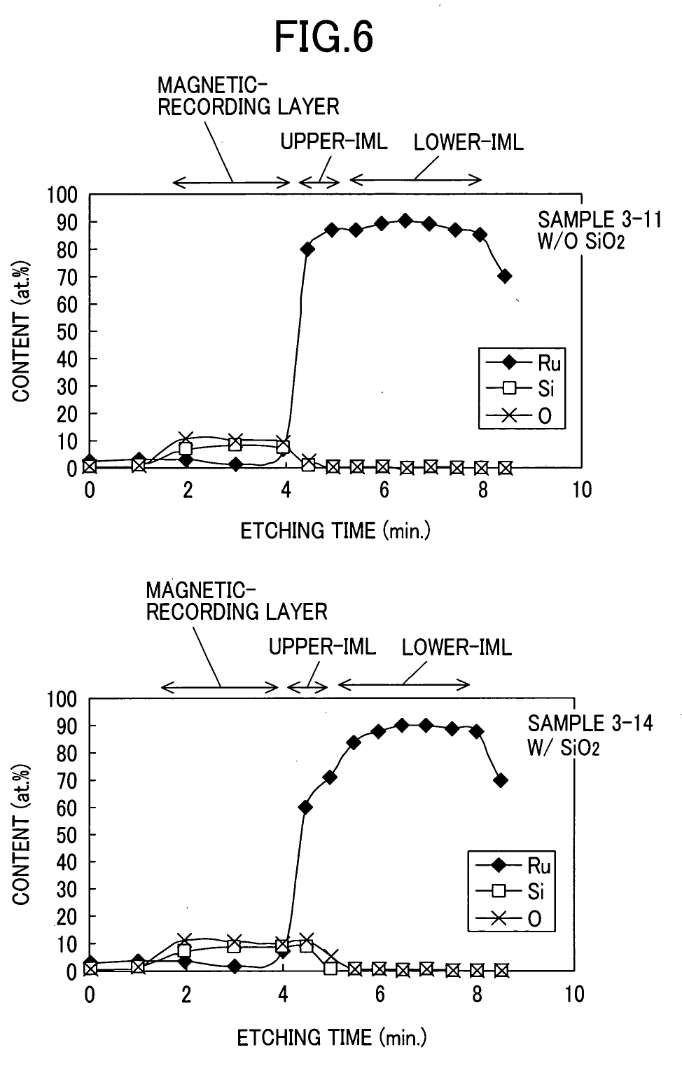

FIG. 6 shows a result of composition analysis by X-ray photoelectron spectroscopy (XPS) with respect to the samples 3-11 and 3-14 in this example 3. The sample 3-14 is found to contain a Si oxide in the upper-intermediate layer.

As a sample to be compared with that in the example 3, the perpendicular magnetic recording medium is manufactured in the same film structure and under the same deposition condition as those in the example 3 except for the lower-intermediate layer and the upper-intermediate layer. The sample is assumed as the sample in the comparative example 3. In the comparative example 3, both of the upper-intermediate layer and the lower-intermediate layer are formed under the same deposition condition.

Tables 2 and 3 show the deposition conditions in the example 3 and in the comparative example 3. The tables 2 and 3 also show the medium coercivity Hc, as well as both mean crystal grain size and mean crystal grain boundary width in the magnetic recording layer, obtained by calculation through observation of crystal grain images and analysis of those images by a TEM (Transmission Electron Microscope).

TABLE 2

| | Lower- and Upper-intermediate layers | | | | | Grain- |
|---|---|---|---|---|---|---|
| | Deposition | | | | Grain | boundary |
| Sample | rate | Ar pressure | Thickness | Hc | size | width |
| name | (nm/s) | (Pa) | (nm) | (kOe) | (nm) | (nm) |
| 3-1 | 1.2 | 0.9 | 5 | 1.1 | 4.0 | 0.83 |
| 3-2 | 1.2 | 0.9 | 20 | 4.7 | 7.2 | 1.05 |
| 3-3 | 1.2 | 0.9 | 30 | 5.2 | 7.5 | 1.07 |
| 3-4 | 1.2 | 2.2 | 5 | 1.2 | 4.3 | 0.85 |
| 3-5 | 1.2 | 2.2 | 20 | 5.5 | 7.4 | 1.08 |
| 3-6 | 1.2 | 2.2 | 30 | 6.2 | 7.5 | 1.09 |
| 3-7 | 0.5 | 2.2 | 5 | 1.4 | 4.5 | 0.84 |
| 3-8 | 0.5 | 2.2 | 15 | 3.8 | 6.7 | 0.92 |
| 3-9 | 0.5 | 2.2 | 20 | 7.2 | 8.0 | 1.12 |
| 3-10 | 0.5 | 2.2 | 30 | 7.5 | 9.1 | 1.15 |

Samples 3-1 to 3-10: Comparative example 3

TABLE 3

| | Upper-intermediate layer | | | | | Grain- |
|---|---|---|---|---|---|---|
| | Deposition | Ar | | | | boundary |
| Sample | rate | pressure | SiO₂ | Hc | Grain size | width |
| name | (nm/s) | (Pa) | (vol. %) | (kOe) | (nm) | (nm) |
| 3-11 | 0.5 | 2.2 | 0.0 | 6.9 | 7.3 | 1.08 |
| 3-12 | 0.5 | 2.2 | 5.0 | 6.7 | 6.9 | 1.07 |
| 3-13 | 0.5 | 2.2 | 12.5 | 6.6 | 6.7 | 1.08 |
| 3-14 | 0.5 | 2.2 | 17.5 | 6.4 | 6.3 | 1.08 |

Samples 3-11 to 3-14: Example 3

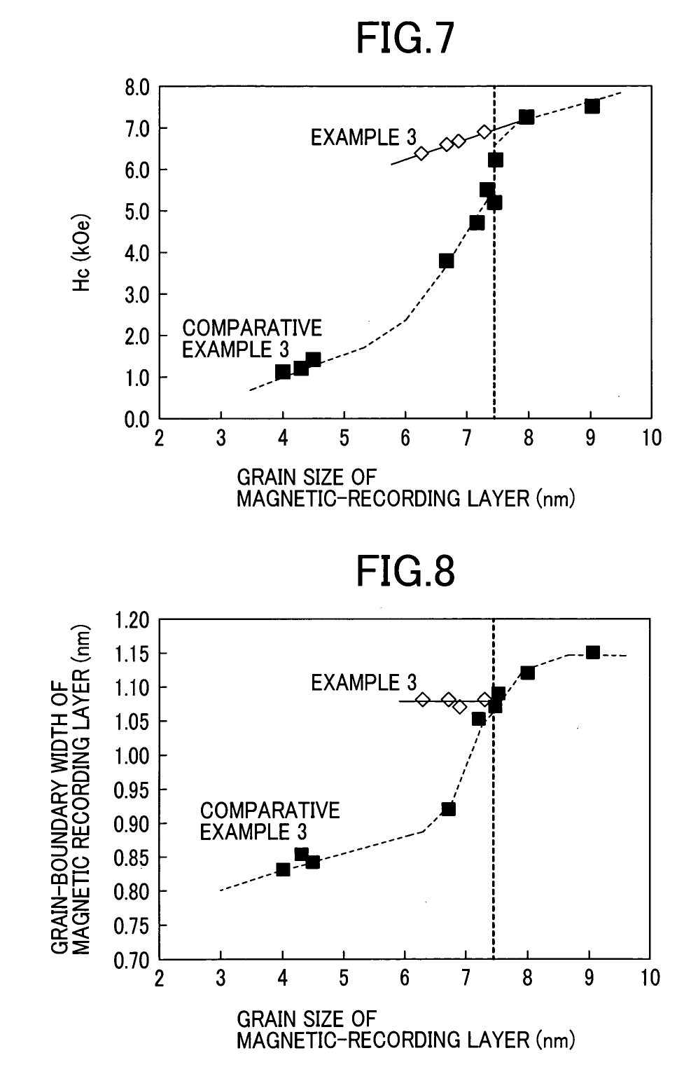

FIG. 7 shows a relationship between the coercivity Hc and the mean crystal grain size of each medium in the example 3 and the comparative example 3. FIG. 8 shows a relationship between the mean crystal grain size and the mean crystal grain boundary width in the magnetic recording layer of each medium in the example 3 and the comparative example 3.

As shown in FIG. 7, if a medium in which the crystal grain size is 7.5 and under, the coercivity Hc is degraded significantly in the comparative example 3.

And, as shown in FIG. 8, because the crystal grain boundary width decreases in accordance with the coercivity Hc at a crystal grain size of 7.5 nm and under, the magnetic isolation of crystal grains from each another might become difficult. On the other hand, in example 3, significant falling of the Hc at a crystal grain size of 7.5 nm is not found. Especially, in samples 3-12 to 3-14 in which a Si oxide is added to the upper-intermediate layer Ru, the crystal grain size is 7 nm[0] and under.

The mean crystal grain boundary width in the magnetic recording layer is 1 nm and over and the crystal grains are isolated enough magnetically from each another. In other words, a magnetic recording medium having a crystal grain size of 7 nm and under and crystal grain boundary width of 1 nm and over is realized if an Ru alloy in which an Si oxide is added to the Ru is used for forming the upper-intermediate layer. As a result, a high media S/N property is obtained. The same effect is also obtained when an Al oxide, Ag, and Cu are added to the Ru instead of the Si oxide.

### Example 4

The perpendicular magnetic recording medium in this example 4 is manufactured in the same structure and under the same deposition condition as those of the sample in the example 3 except for the lower-intermediate layer. In this example 4, the Ar gas pressure is set at 0.9 Pa when depositing the lower-intermediate layer and the film thickness is changed at each of the depositing rates of 6.5 nm/s and 1.0 nm/s.

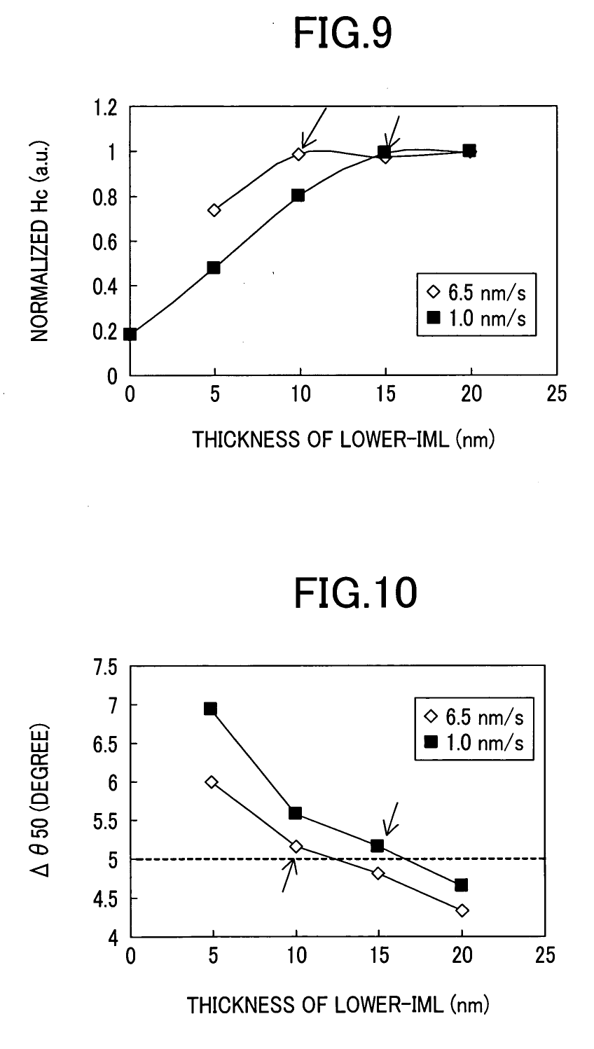

FIG. 9 shows a relationship between the film thickness of the lower-intermediate layer and the normalized coercivity Hc. FIG. 10 shows a relationship between the film thickness of the lower-intermediate layer and a full width at half-maximum Δθ₅₀ of the Rocking curves of the Ru (0002) diffraction peak measured by an X-ray diffraction method.

The normalized coercivity Hc shown in FIG. 9 is a value of the coercivity Hc normalized by the value of the coercivity of a 20 nm lower-intermediate layer. When a comparison is made between FIGS. 9 and 10, the Hc value decreases at a film thickness at which the a full width at half-maximum Δθ₅₀ of the Rocking curves of the Ru (0002) diffraction peak is over 5° at any deposition rate. This admits that if the a full width at half-maximum Δθ₅₀ of the Rocking curves of the Ru (0002) diffraction peak goes over 5°, the crystallo graphic orientation of the magnetic recording layer is degraded significantly.

In other words, in order to further reduce the crystal grain size without degrading the crystallo graphic orientation in the magnetic recording layer, the full width at half-maximum Δθ₅₀ of the Rocking curves of the Ru (0002) diffraction peak measured by an X-ray diffraction method is required to be 5° and under. And, the same effect is also obtained when an Al oxide, Ag, and Cu are added to the Ru instead of the Si oxide.

### Example 5

The perpendicular magnetic recording medium in this example 5 is manufactured in the same film structure and under the same deposition condition as those in the example 3 except for the upper-intermediate layer and the lower-intermediate layer. In the example 5, as the lower-intermediate layer, a 15 nm Ru film formed at an Ar gas pressure of 0.5 Pa and a deposition rate of 6.5 nm/s is used and the Si oxide content in the upper-intermediate layer is changed.

As a sample to be compared with that in the example 5, the sample 3-11 is used. The sample 3-11 is manufactured in the same film structure and under the same deposition condition as those in the example 5 except that no Si oxide is added to the upper-intermediate layer.

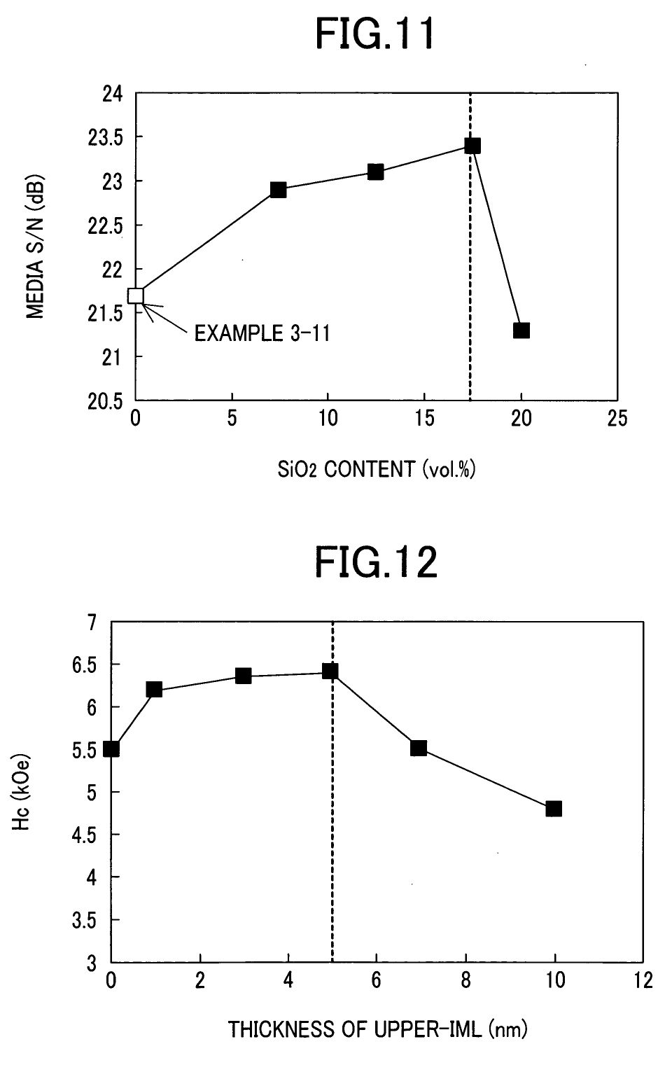

FIG. 11 shows a relationship between the content of the Si oxide in the upper-intermediate layer and the media S/N value. At that time, the content of the Si oxide occupied in the recording layer is 17.5 vol. %. As shown in FIG. 11, if the content of the Si oxide in the upper-intermediate layer is 17.5 vol. % and under the media S/N value is higher than that of the sample 3-11.

If the Si oxide is added to the upper-intermediate layer by more than 17.5 vol. %, however, the media S/N value decreases significantly. This is because if a Si oxide is added to the upper-intermediate layer at a content higher than that added to the recording layer, the crystallo graphic orientation in the recording layer is degraded.

In other words, it is understood that a relationship of (the content of Si oxide in the upper-intermediate layer)<(the content of Si oxide in the magnetic recording layer) is required to be satisfied to reduce the crystal grain size more while keeping the good crystallo graphic orientation of the magnetic recording layer). And, the same effect as that described above is also obtained when an Al oxide, Ag, and Cu are added to the Ru instead of the Si oxide.

### Example 6

The perpendicular magnetic recording medium in this example 6 is manufactured in the same film structure and under the same deposition condition as those of the sample 3-14 in the example 3. In this example 6, the film thickness of the upper-intermediate layer is changed.

FIG. 12 shows a relationship between the film thickness of the upper-intermediate film and the Hc value. As shown in FIG. 12, if the film thickness is 5 nm and under, the Hc value increases gradually in proportion to an increase of the film thickness of the upper-intermediate layer. If the film thickness goes over 5 nm, however, the Hc value decreases. This may be because if the upper-intermediate layer is too thick, the crystallo graphic orientation of the recording layer is degraded.

In other words, it is understood that the upper-intermediate layer should be limited at 5 nm and under in thickness to reduce the crystal grain size more while keeping the good crystallo graphic orientation of the magnetic recording layer. And, the same effect as that described above is also obtained when an Al oxide, Ag, and Cu are added to the upper-intermediate layer instead of the Si oxide.

### Example 7

The perpendicular magnetic recording medium in this example 7 is manufactured in the same film structure and under the same deposition condition as those in the example 1 except for the lower-intermediate layer and the upper-intermediate layer. Table 4 shows the deposition condition for each of the lower-intermediate layer and the upper-intermediate layer.

TABLE 4

| | Lower-intermediate | | Upper-intermediate | | | | |
|---|---|---|---|---|---|---|---|
| | layer (15 nm) | | layer (5 nm) | | | Grain- | |
| | Deposition | | Deposition | Ar | | boundary | |
| Sample | rate | Ar pressure | rate | pressure | Δθ₅₀ | width | Media S/N |
| name | (nm/s) | (Pa) | (nm/s) | (Pa) | (degree) | (nm) | (dB) |
| 7-1 | 0.5 | 2.2 | 0.5 | 2.2 | 5.3 | 1.10 | 18.2 |
| 7-2 | 0.5 | 2.2 | 6.5 | 2.2 | 5.1 | 0.95 | 17.3 |
| 7-3 | 0.5 | 2.2 | 0.5 | 0.9 | 5.2 | 1.02 | 17.8 |
| 7-4 | 0.5 | 2.2 | 6.5 | 0.9 | 4.9 | 0.83 | 15.4 |
| 7-5 | 0.5 | 0.9 | 0.5 | 2.2 | 5.0 | 1.10 | 20.9 |
| 7-6 | 6.5 | 2.2 | 0.5 | 2.2 | 4.9 | 1.05 | 21.0 |
| 7-7 | 6.5 | 0.9 | 0.5 | 2.2 | 4.8 | 1.08 | 21.5 |

Samples 7-1 to 7-4: Comparative example 7
Samples 7-5 to 7-7: Example 7

Both of the upper-intermediate layer and the lower-intermediate layer of the sample 7-1 are manufactured under the same deposition conditions. In sample 7-2, the upper-intermediate layer is manufactured at a deposition rate higher than that of the lower-intermediate layer. In the sample 7-3, the upper-intermediate layer is manufactured at an Ar pressure lower than that of the lower-intermediate layer. In the sample 7-4, the upper-intermediate layer is manufactured at a deposition rate higher than the lower-intermediate layer and at an Ar pressure lower than that thereof. In those samples 7-2 to 7-4, the a full width at half-maximum Δθ₅₀ of the Rocking curves of the Ru (0002) diffraction peak is smaller than that of the sample 7-1, but the grain-boundary width is smaller than that of the sample 7-1. Therefore, in samples 7-2 to 7-4, the media S/N value is lower than that of the sample 7-1.

On the other hand, when compared with the sample 7-1, the full width at half-maximum Δθ₅₀ of the Rocking curves of the Ru (0002) diffraction peak is smaller in each of the sample 7-5 in which the upper-intermediate layer is deposited at an Ar pressure higher than that of the lower-intermediate layer, the sample 7-6 in which the upper-intermediate layer is deposited at a deposition rate lower than the lower-intermediate layer, and the sample 7-7 in which the upper-intermediate layer is deposited at an Ar pressure higher than that of the lower-intermediate layer and at a deposition rate lower than that thereof. In addition, the mean crystal grain boundary width in each of those samples is 1 nm and over, denoting a high media S/N value.

This is why the upper-intermediate layer is required to be formed by either of the spattering at a deposition rate lower than that of the lower-intermediate layer or the spattering at an Ar pressure higher than the lower-intermediate layer.

1. A perpendicular magnetic recording medium, comprising:
a substrate;
a soft magnetic underlayer formed on said substrate;
an intermediate layer formed on said soft magnetic underlayer; and
a magnetic recording layer formed on said intermediate layer;
wherein said intermediate layer consists of at least two or more layers and contains ruthenium (Ru) or an Ru-based alloy;
wherein said magnetic recording layer is made of a material containing a CoCrPt alloy containing Cobalt (Co), chromium (Cr), and platinum (Pt), as well as oxygen; and
wherein a full width at half-maximum Δθ₅₀ of the Rocking curves of the Ru (0002) diffraction peak measured by an X-ray diffraction (XRD) method is 5° and under.

2. The perpendicular magnetic recording medium according to claim 1;
wherein said Ru alloy contains Ru by 50 at. % and over.

3. The perpendicular magnetic recording medium according to claim 1,
wherein the average crystal grain size of said magnetic recording medium, which is obtained by calculation through observation of crystal grains and analysis of observed images using a Transmission Electron Microscope (TEM, hereinafter) is 7.5 nm and under.

4. The perpendicular magnetic recording medium according to claim 1,
wherein the average crystal grain boundary width of said magnetic recording medium, which is obtained by calculation through observation of crystal grains and analysis of observed images using a TEM is 1 nm and over.

5. A perpendicular magnetic recording medium, comprising:
a substrate;
a soft magnetic underlayer formed on said substrate;
an intermediate layer formed on said soft magnetic underlayer; and
a magnetic recording layer formed on said intermediate layer;
wherein said magnetic recording layer is made of a CoCrPt alloy containing Cobalt (Co), chromium (Cr), and platinum (Pt) and another alloy containing oxygen;
wherein said intermediate layer consists of a lower intermediate layer and an upper intermediate layer;
wherein said upper intermediate layer is made of Ru or an alloy in which at least one of an Si oxide, an Al oxide, Ag, and Cu is added to the Ru; and
wherein said lower intermediate layer is made of Ru or a Ru alloy in which at least one of Co and Cr is added to the Ru.

6. The perpendicular magnetic recording medium according to claim 5,
wherein a full width at half-maximum Δθ₅₀ of the Rocking curves of the Ru (0002) diffraction peak measured by an X-ray diffraction XRD method is 5° and under.

7. The perpendicular magnetic recording medium according to claim 5,
wherein the average crystal grain size of said magnetic recording medium, which is obtained by calculation through observation of crystal grains and analysis of observed images using a TEM, is 7 nm and under.

8. The perpendicular magnetic recording medium according to claim 5,
wherein the average crystal grain boundary width of said magnetic recording medium, which is obtained by calculation through observation of crystal grains and analysis of observed images using a TEM, is 1 nm and over.

9. The perpendicular magnetic recording medium according to claim 5,
wherein said upper intermediate layer and said magnetic recording layer satisfy a relationship of (the content of Si oxide, an Al oxide, Ag, and Cu added in the upper-intermediate layer)≦(the content of Si oxide, an Al oxide, Ag, and Cu added in the magnetic recording layer).

10. The perpendicular magnetic recording medium according to claim 5,
wherein said upper intermediate layer is 5 nm and under in thickness.

11. The perpendicular magnetic recording medium according to claim 5,
wherein the deposition rate of said upper intermediate layer is lower than that of said lower intermediate layer.

12. The perpendicular magnetic recording medium according to claim 5,
wherein said intermediate layer is deposited in an Ar-gas atmosphere and the gas pressure is higher than that for depositing said lower intermediate layer.

13. A method for manufacturing a perpendicular magnetic recording medium,
wherein a soft magnetic underlayer is formed on a substrate;
wherein a lower intermediate layer is formed on said soft magnetic underlayer, said lower intermediate layer containing Ru or an Ru alloy in which at least one of Co and Cr is added to the Ru;
wherein an upper intermediate layer is formed on said lower intermediate layer at a deposition rate lower than that of said lower intermediate layer, said upper intermediate layer containing Ru or an alloy in which at least one of an Si oxide, an Al oxide, Ag, and Cu is added to the Ru; and
wherein said magnetic recording layer is formed on said upper intermediate layer.

14. The method according to claim 13,
wherein said upper intermediate layer and said lower intermediate layer are deposited in an Ar gas atmosphere; and
wherein said upper intermediate layer is deposited at a gas pressure higher than that of said lower intermediate layer.

15. A method for manufacturing a perpendicular magnetic recording medium,
wherein a soft magnetic underlayer is formed on a substrate;
wherein a lower intermediate layer is formed on said soft magnetic underlayer, said lower intermediate layer containing Ru or an Ru alloy in which at least one of Co and Cr is added to the Ru;
wherein an upper intermediate layer is formed on said lower intermediate layer at a deposition rate lower than that of said lower intermediate layer, said upper intermediate layer containing Ru or an alloy in which at least one of an Si oxide, an Al oxide, Ag, and Cu is added to the Ru; and
wherein said magnetic recording layer is formed on said upper intermediate layer.

16. The method according to claim 14,
wherein said upper intermediate layer is formed at a deposition rate lower than that of said lower intermediate layer.
